(19) United States
(12) Patent Application Publication
(10) Pub. No.: US 2010/0073449 A1
(43) Pub. Date: Mar. 25, 2010

(54) INKJET PRINTER

(75) Inventors: Akihito Yamamoto, Wakayama (JP); Yoshitsugu Tokai, Wakayama (JP)

Correspondence Address: BLACK LOWE & GRAHAM, PLLC, 701 FIFTH AVENUE, SUITE 4800, SEATTLE, WA, 98104, US

(73) Assignee: NORITSU KOKI CO., LTD., Wakayama (JP)

(21) Appl. No.: 12/559,371

(22) Filed: Sep. 14, 2009

(30) Foreign Application Priority Data
Sep. 19, 2008 (JP) 2008-241364
Sep. 19, 2008 (JP) 2008-241369

(51) Int. Cl. B41J 2/01

(52) U.S. Cl. 347/104

(57) ABSTRACT

In a consecutive processing in which an inkjet printer A consecutively performs printing on a plurality of media sheets and cutting the front ends and the rear ends of the media sheets, a feed interval between any two consecutive media sheets in a cutting section is set larger than that in a printing section.

### CROSS REFERENCE TO RELATED APPLICATIONS

This application claims priority to Japanese Patent Applications Nos. 2008-241364 and 2008-241369 filed on Sep. 19, 2008, the disclosures of which including the specification, the drawings, and the claims are hereby incorporated by reference in its entirety.

### BACKGROUND

The present disclosure relates to inkjet printers for printing on media sheets (cut sheets cut to have predetermined sizes).

Conventionally, an inkjet printer used for a photographic printing system or the like includes a media sheet housing chamber that houses a long rolled media sheet. The media sheet housed in the media sheet housing chamber is supplied to a printing section. Then, in the printing section, ink is ejected from a print head to the media sheet supplied from the media sheet housing section, thereby printing on the media sheet. The printed media sheet is cut by a cutter to have a predetermined length, and then, is fed to a discharge point where a discharge tray or the like is provided.

For cutting the media sheet, in Japanese Unexamined Patent Application Publication 2007-261038, for example, a part of the media sheet between images is cut off as a band-shaped chip. Then, the chip is allowed to fall into a cutter chip recovery box provided below the cutter.

The above publication discloses, as a cutter for cutting a media sheet, a disk cutter that cuts a media sheet by rotating a disk-shaped blade while moving it from one end to the other end in the width direction of the media sheet. As another example of the cutter, a so-called guillotine cutter has been known which includes a fixed blade and a movable blade extending in the width direction of a feed path and disposed with the feed path interposed. The media sheet is cut by moving the movable blade to the fixed blade with the fixed blade fixed and with the media sheet interposed.

Further, in another inkjet printer used in a photographic printing system or the like as disclosed in, for example, Japanese Unexamined Patent Application Publication 2006-27812, a platen having a surface in which a plurality of suction holes are formed is opposed to the print head, and a suction device is provided to generate at the surface of the platen negative pressure through the suction holes, thereby sucking and holding a media sheet being fed on the platen for the purpose of increasing printing quality by ensuring flatness of the media sheet at printing.

### SUMMARY

Incidentally, when a media sheet is a cut sheet cut to have a predetermined size, the media sheet usually needs not to be cut.

However, in photographic printing on such a cut sheet, borderless printing for printing an image on the entirety of a media sheet may be performed in some cases. In the borderless printing, the front end part and the rear end part of the media sheet must be cut. Specifically, in the borderless printing, ink is ejected to the absolute edges in the width direction of a media sheet, and an ink absorber provided on the surface of the platen absorbs the ink beyond the edges. On the other hand, when the ink is ejected toward the front edge and the rear edge of the media sheet, the ink may be sucked into the suction holes of the platen by suction through the suction holes to degrade printing quality, and smear the surface of the platen. For this reason, printing is performed so that a predetermined amount of margins are formed at the front end part and the rear end part of a media sheet. Then, the margins are cut by a cutter to make a printed image borderless.

Here, in the case where the guillotine cutter cuts the margins at the front end part and the rear end part of a media sheet, since the media sheet is usually laid horizontally, one of the fixed blade and the movable blade is arranged above the media sheet feed path, while the other is arranged below the media sheet feed path. In the case where the upper blade of the cutter is the movable blade and the lower blade is the fixed blade, the respective sides of a chip in the direction where the media sheet is fed, which is generated by cutting the end parts of the media sheet, may be on the lower blade (the fixed blade) and, for example, a guide plate for guiding a media sheet or the like arranged on the upstream side of the cutter, thereby leaving the chip on the feed path. The chip is usually pushed by a subsequent media sheet, and then falls into the cutter chip recovery box. Thus, no significant problem is caused.

However, if a chip generated by cutting the rear end part of the final media sheet remains on the feed path, since no media sheet to be fed next exists, the chip continues to remain on the feed path. This is not favorable. For this reason, the rear end part of the final media sheet should not be cut by the cutter, and the operator should take out and cut it manually, thereby reducing operation efficiency.

In view of the above, it is preferable to set the upper blade as the fixed blade and the lower blade as the movable blade. When the lower blade is moved upward to cut a media sheet, the lower blade blows a chip generated by this cutting upward of the feed path. Then, the chip falls into the cutter chip recovery box.

However, in printing sections of the conventional inkjet printers, feed intervals between consecutively fed media sheets are set small as far as possible. Cutting a media sheet by moving the lower blade upward with this small intervals left may cause the following problems.

That is, in the printing sections, the feed interval of any two consecutive media sheet is set small. This can suppress suction of the ink through the suction holes located between the two media sheets and can improve printing performance of the inkjet printer. When the two media sheets are fed to and cut by the cutter with this small feed interval left, the possibility increases that a chip generated by cutting the rear end part of a preceding media sheet of the two media sheets may fall on a subsequent media sheet after being blown upward, and a chip generated by cutting the front end part of the subsequent media sheet may fall on the preceding media sheet. If the media sheets carrying the chips are fed, paper jam may be caused at a feed roller or the guide plate. Further, the media sheets may be displaced in their width direction from the standard position.

The present invention has been made in view of the foregoing, and its objective is to prevent a chip blown upward when the front end part or the rear end part of a media sheet is cut from falling on an adjoining preceding or subsequent media sheet.

To attain the above objective, an inkjet printer having the following configuration is provided. That is, an inkjet printer, includes: a printing section which prints on media sheets by ejecting ink from a print head; a media sheet supply section which supplies media sheets to the printing section; a feeding section which is provided at the printing section, and which feeds the media sheets supplied from the media sheet supply section to a side opposite to a side of the media sheet supply section when the media sheets is being printed; and a cutting section which sequentially cuts a front end part and a rear end part of the media sheets fed from the feeding section and printed by the printing section, wherein the cutting section includes a cutting/feeding section which horizontally feeds the printed media sheets to a side opposite to a side of the printing section, and a cutter including an upper blade and a lower blade arranged above and below a media sheet feed path of the cutting/feeding section, the cutting section cuts media sheets in a manner that, when a to-be-cut part of the media sheets is positioned between the upper blade and the lower blade of the cutting/feeding section, the lower blade is moved upward with the upper blade fixed, in a consecutive processing in which the inkjet printer consecutively prints and cuts a plurality of media sheets, the feeding section and the cutting/feeding section consecutively feed the plurality of media sheets with a feed interval left therebetween in a direction where the media sheets are fed, and in the consecutive processing by the inkjet printer, the feed interval between any two consecutive media sheets in the cutting section is larger than that in the printing section.

By this configuration, a chip generated by cutting the front end part or the rear end part of a media sheet by the lower blade is prevented from falling on an adjoining preceding or subsequent media sheet after being blown upward above the feed path.

In detail, in the printing section, the feed interval between any two consecutive media sheets is set small as far as possible (e.g., about 2 mm) for the purpose of suppressing ink suction through the suction holes located between the two media sheets and improving printing performance of the inkjet printer. If the feed interval between the two media sheets in the cutting section remains the same as the small feed interval in the printing section, a chip generated by cutting the rear end part of the preceding sheet (on the downstream side) of the two media sheets may fall on the subsequent sheet (on the upstream side) after being blown upward. Further, a chip generated by cutting the front end part of the subsequent media sheet may fall on the preceding media sheet.

However, in the above inkjet printer, the feed interval between the two media sheets in the cutting section is larger that in the printing section. This can prevent a chip generated by cutting the rear end parts of the media sheets from falling on the subsequent adjoining media sheet and prevent a chip generated by cutting the front end parts of the media sheets from falling on the preceding adjoining media sheet. In turn, paper jam and displacement in their width direction of the media sheets, which are caused due to the presence of such a chip, can be prevented.

In the above inkjet printer, it is preferable that the cutting/feeding section includes a pre-cutting feeding section and a post-cutting feeding section respectively arranged on an upstream side and a downstream side of the cutter, and driven independently of each other for feeding media sheets, and in the consecutive processing by the inkjet printer, when the post-cutting feeding section feeds a preceding sheet of the two media sheets while the pre-cutting feeding section feeds a subsequent sheet of the two media sheets, a feed rate of the preceding sheet is higher than that of the subsequent sheet.

This can increase the interval between the preceding sheet and the subsequent sheet in the cutting section. As a consequence, the feed interval between the two media sheets in the cutting section can be easily increased more than that in the printing section.

Preferably, the above inkjet printer further includes, in the printing section: a platen opposed to the print head and having a support surface in which a plurality of suction holes are formed; and a suction device which sucks through the suction holes and hold media sheets on the support surface of the platen, wherein the feeding section includes a pre-printing feeding section and a post-printing section respectively arranged on an upstream side and a downstream side of the platen, and driven independently of each other for feeding media sheets, and when a rear end of a preceding sheet and a front end of a subsequent sheet of the two media sheets are located between the pre-printing feeding section and the post-printing feeding section in the consecutive processing by the inkjet printer, the pre-printing feeding section perfolins follow-up feed in which the subsequent sheet follows the preceding sheet at a predetermined interval.

This allows the pre-printing feeding section to perform follow-up feed. Thus, the number of the suction holes located between two consecutive media sheets can be reduced stably, thereby suppressing degradation of printing quality caused by ink suction through the suction holes. Further, although follow-up feed by the pre-printing feeding section can reduce the feed interval between two consecutive media sheets in the printing section, the feed interval between the two media sheets can be increased in the cutting section on its downstream side. Thus, degradation of printing quality can be suppressed, and a chip generated by cutting the front end part or the rear end parts of media sheets and blown upward can be prevented from falling on the preceding or subsequent adjoining media sheet.

Preferably, in the inkjet printer where the pre-printing feeding section performs follow-up feed, the pre-printing feeding section includes a press fit type pre-printing feed roller pair which feeds media sheets by being driven by a first motor, the post-printing feeding section includes a press fit type post-printing feed roller pair which feeds media sheets by being driven by a second motor, the first motor includes a first rotary encoder which detects a rotation angle of the first motor, the second motor includes a second rotary encoder which detects a rotation angle of the second motor, and the follow-up feed by the pre-printing feeding section is performed by driving the first motor on the basis of values detected by the first and second rotary encoders.

By this comparatively simple configuration, the feed interval between two consecutive media sheets can be kept accurately in the follow-up feed. As a consequence, high quality printing can be achieved at low cost.

Preferably, on the support surface of the platen, the plurality of suction holes are arranged such that a plurality of rows of the suction holes, extending along a row direction orthogonal to a feeding direction in which media sheets is fed, are arranged at intervals along the feeding direction, and the predetermined interval is smaller than a minimum of the intervals at which adjoining ones of the plurality of the rows are arranged.

This can prevent a plurality of suction holes from being concurrently positioned between the two consecutive media sheets. Thus, degradation of printing quality caused by ink suction through the suction holes can be minimized.

### BRIEF DESCRIPTION OF THE DRAWINGS

FIG. 1 is a perspective view showing an external appearance of an inkjet printer according to an example embodiment.

FIG. 2 is a schematic view of an internal configuration of the inkjet printer when viewed from the side.

FIG. 3 is a cross-sectional view specifically showing the inside of a cassette.

FIG. 4 is a side view specifically showing a printing section and a U-turn section.

FIG. 5 is a plan view specifically showing the printing section.

FIG. 6 is a schematic view showing a state where a switchback roller pair of a switchback section receives a media sheet fed from a reverse feeding section.

FIG. 7 is an illustration corresponding to FIG. 6, which shows a state where a driven roller of the switchback roller pair is switched to a second position.

FIG. 8 is an illustration corresponding to FIG. 6, which shows a state where the switchback roller pair switches back a media sheet to a supply roller pair.

FIG. 9 is an illustration corresponding to FIG. 6, which shows a state where a media sheet is manually fed and inserted through a manual paper feed/insertion opening.

FIG. 10 is a perspective view specifically showing the switchback section.

FIG. 11 is an illustration when viewed in the direction of an arrow C in FIG. 10.

FIG. 12 is an illustration corresponding to FIG. 11, which shows a state where driven rollers of the switchback roller pair and the supply roller pair are in a press-fit released state.

FIG. 13 is an illustration corresponding to FIG. 2, which shows a state where a duplex printing unit is detached from a printer main body.

FIG. 14 is a schematic view showing a configuration of a feeding section.

FIG. 15 is a perspective view showing the printing section and the vicinity thereof.

FIG. 16 is a side view showing the main part of the feeding section.

FIGS. 17A to 17C are schematic views showing operation of the feeding section under transfer control.

FIGS. 18A and 18B are schematic views showing operation of the feeding section under media sheet follow-up feed control.

### DETAILED DESCRIPTION

Example embodiments of the present invention will be described below with reference to the accompanying drawings. The following example embodiments merely describes preferred examples, and are not intended to limit the scope of the present invention, its applicable objects, and its use.

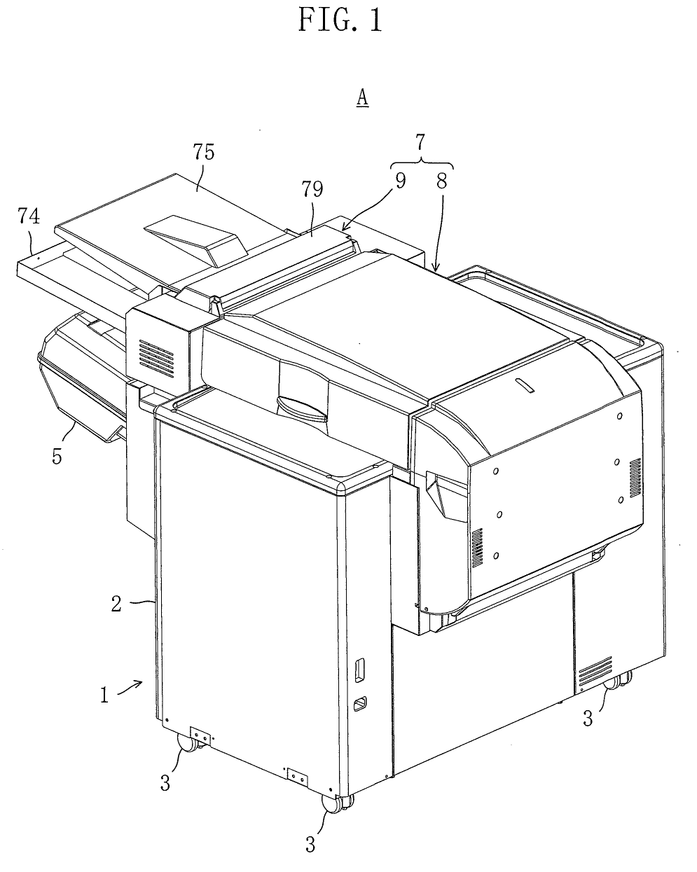

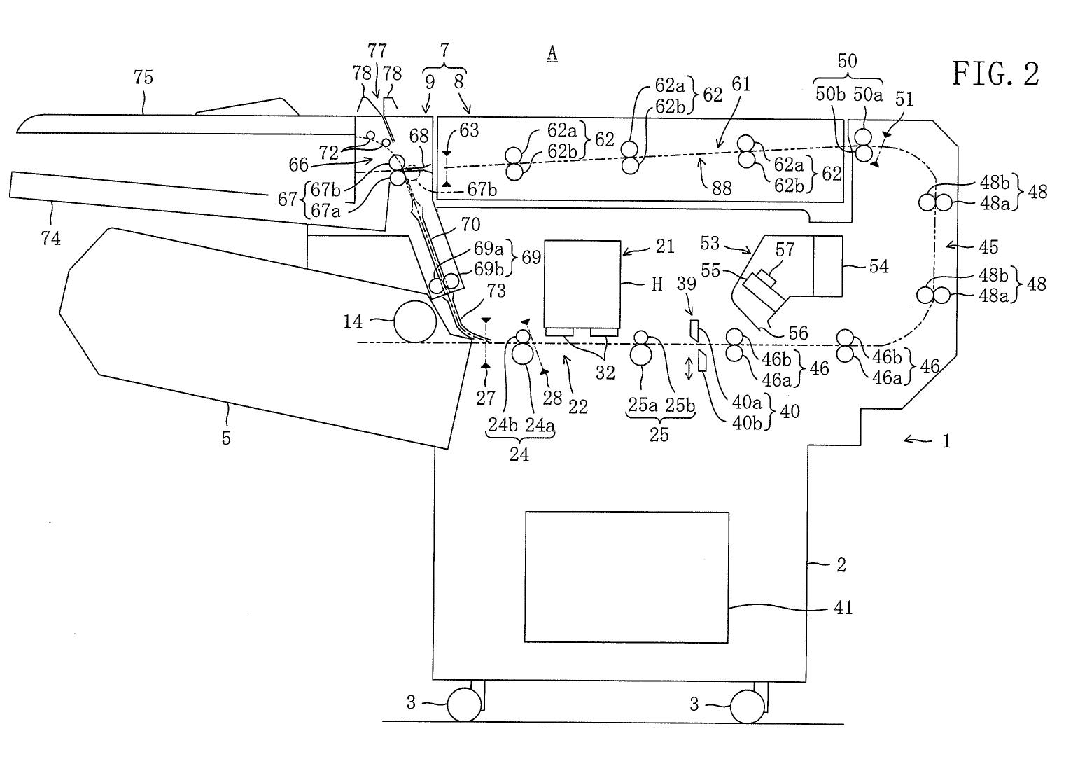

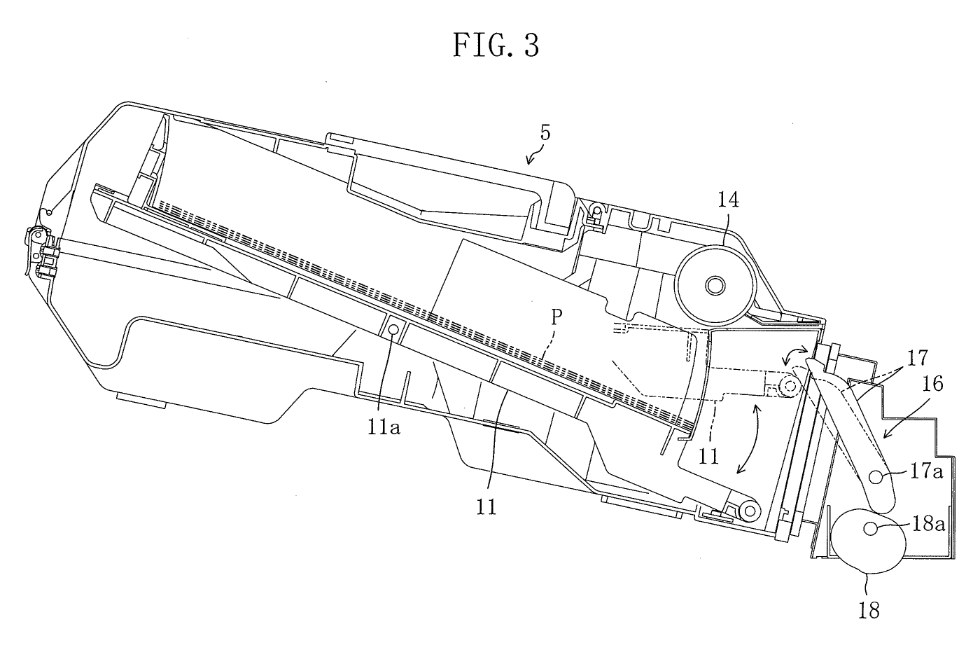

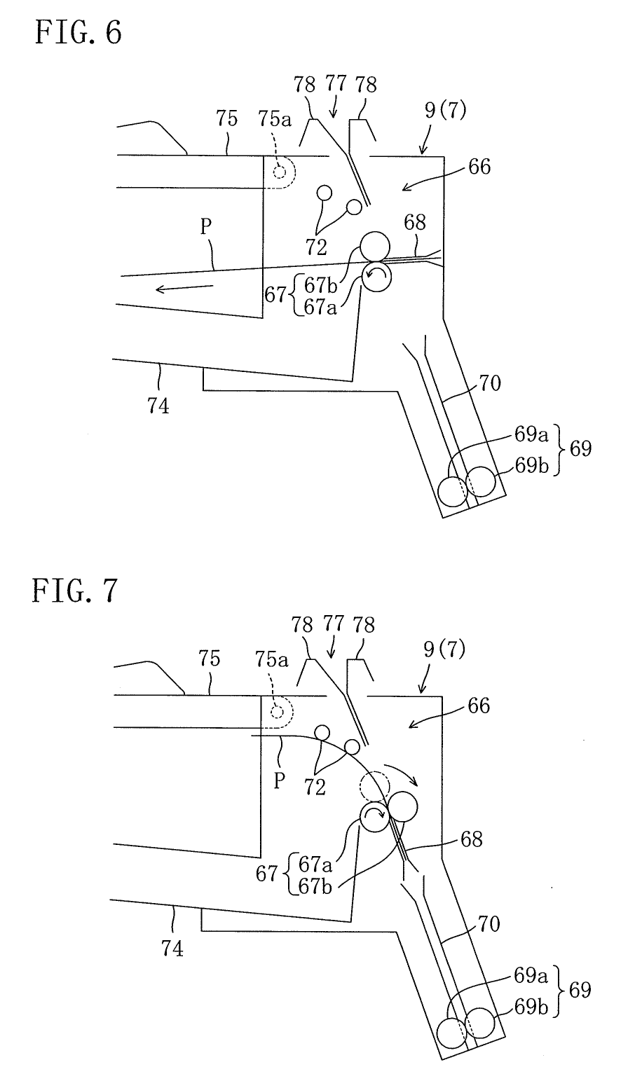

FIG. 1 shows an external appearance of an inkjet printer A according to an example embodiment. FIG. 2 schematically shows an inside configuration of the inkjet printer A. The inkjet printer A is used for a photographic printing system and, for example, prints on a media sheet P (see FIG. 3, FIG. 6, etc., for example) on the basis of image data transmitted via a communication cable from a reception block that obtains the image data and performs necessary correction. The media sheet P is a cut sheet cut to have a predetermined size. A plurality of sizes can be set in advance as this size (the lengths and widths of the media sheets P are determined according to the sizes of the media sheets).

The inkjet printer A includes a printer main body 1, a cassette 5, and a duplex printing unit 7. The printer main body 1 includes a housing 2 having a lower surface provided with a plurality of wheels 3. The cassette 5 is detachably attached to the upper part of one side of the housing 2 of the printer main body 1, and is capable of housing a plurality of media sheets P stacked in their thickness direction. The duplex printing unit 7 is detachably attached to the upper surface of the housing 2. It is noted that, in the present example embodiment, the side where the cassette 5 is attached (left in FIG. 2) is referred to as a printer front side, and the side opposite thereto (right in FIG. 2) is referred to as a printer rear side. Further, the direction perpendicular to the sheet in FIG. 2 is referred to as a printer transverse direction, and agrees with the transverse direction of media sheets P housed in the cassette 5 and fed in the printer main body 5 and the duplex printing unit 7.

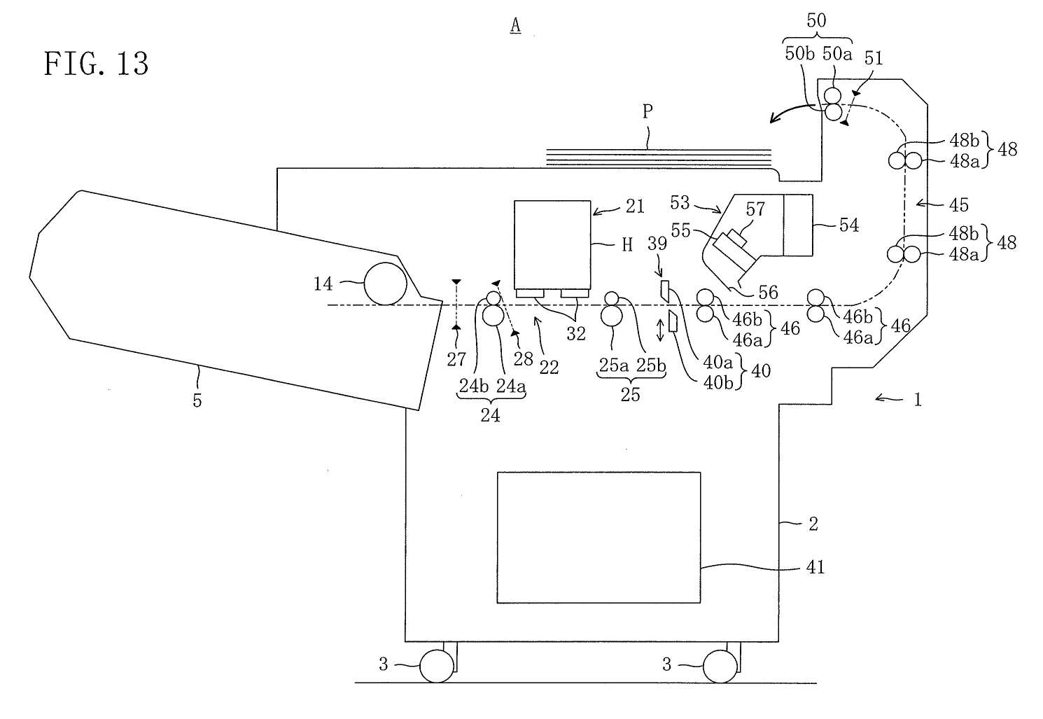

As shown in FIG. 2, by attaching the duplex printing unit 7 to the printer main body 1, duplex printing on both sides of a media sheet P is enabled, as will be described later. Binding a plurality of media sheets P having received duplex printing enables formation of a photographic album or a photographic book. On the other hand, for simplex printing on only one side of the media sheet P, that is, in the case where duplex printing is unnecessary, the duplex printing unit 7 is detached from the printer main body 1 usually (see FIG. 13). It is noted that, even when the duplex printing unit 7 is attached to the printer main body 1, simplex printing on a media sheet P can be performed.

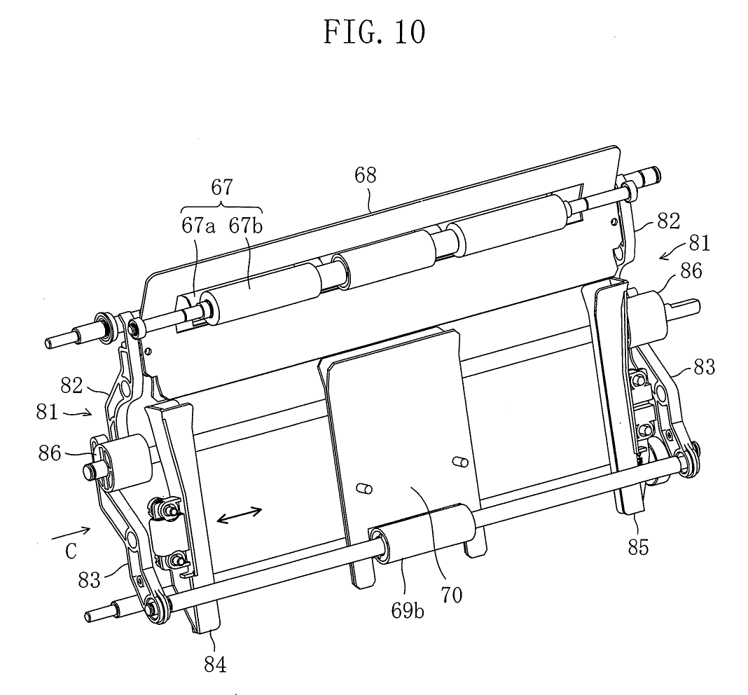

The cassettes 5 is exchanged according to the size of a media sheet P. The operator inputs through a manual switch (not shown) the size (length and width) of the media sheet P corresponding to the cassette 5 after the cassette 5 is attached to the printer main body 1. Further, the operator operates an operation member (not shown) to align width restricting members 84, 85 (see FIG. 10) of a correction mechanism 81, which will be described later, with the position corresponding to the width of the media sheet P. Alternatively, for example, an IC chip storing information indicating the size of a media sheet P and the like may be provided in the cassette 5 so that the printer main body 1 can read the stored information of the IC chip when the cassette 5 is attached thereto. This can eliminate the need for operator's input operation. Additionally, a motor may automatically perform alignment of the width restricting members 84, 85 of the correction mechanism 81 according to operator's input through the operation switch or the read information stored in the IC chip.

As shown in detail in FIG. 3, a set tray 11 for setting media sheets P stacked in their thickness direction is provided in the cassette 5. The set tray 11 is pivotally supported about an axis 11a extending in the printer transverse direction (right and left) at the approximate center in the printer longitudinal direction (back and forth) of the set tray 11 within the cassette 5. The set tray 11 receives spring force so as to rotate in the direction that raises the printer rear side end of the set tray 11. This allows the uppermost media sheet P of a plurality of media sheets P set on the set tray 11 to come into contact with a feed roller 14 provided in the upper part of the printer rear side end in the cassette 5.

The feed roller 14 is driven and rotated in the anticlockwise direction in FIG. 3 by a motor (not shown) provided in the printer main body 1. When the motor drives and rotates the feed roller 14, only the uppermost media sheet P is moved toward the printer rear end to be fed outside the cassette 5. At this time, when the feed roller 14 is rotated by a predetermined amount, a tray pushdown mechanism 16 lowers the printer rear side end of the set tray 11 so that the uppermost media sheet P will not drag the media sheets P located under the uppermost media sheet P, and that a plurality of media sheets P are not simultaneously fed outside the cassette 5.

The tray pushdown mechanism 16 includes, within the printer main body 1, a tray pushdown lever 17 pivotally supported about an axis 17a extending in the printer transverse direction, and a lever pivot cam 18 for rotating the tray pushdown lever 17 about the axis 17a. The lever pivot cam 18 is configured to rotate about an axis 18a by a motor (not shown). Further, when the cassette 5 is attached to the printer main body 1, one end of the tray pushdown lever 17 enters to be located above the printer rear side end of the set tray 11 within the cassette 5. On the other hand, the other end of the tray pushdown lever 17 is in contact with the cam surface of the layer pivot cam 18. In order to always maintain this contact state, a spring pushes the tray pushdown lever 17 so that the other end moves toward the lever pivot cam 18, that is, so that the one end moves upward.

When the feed roller 14 is rotated by the predetermined amount, the lever pivot cam 18 rotates to cause the one end of the tray pushdown lever 17 to come into contact with and push down the printer rear side end of the set tray 11. This can prevent the uppermost media sheet P from dragging the media sheets P located under the uppermost media sheet P, thereby preventing a plurality of media sheets P from being simultaneously fed outside the cassette 5. It is noted that, when the lever pivot cam 18 makes a half turn, the one end of the tray pushdown lever 17 starts rising to cause the spring to raise the printer rear side end of the set tray 11, thereby allowing a media sheet P that will be the uppermost media sheet P next to come into contact with the feed roller 14. When the lever pivot cam 18 makes full turn, the lever pivot cam 18 stops rotating, and the tray pushdown lever 17 returns to the initial state.

The media sheet P fed outside the cassette 5 by the feed roller 14 is supplied to a printing section 21, which will be described later, in the printer main body 1. Therefore, the feed roller 14 of the cassette 5 corresponds to a media sheet supply section which supplies a media sheet P to the printing section 21.

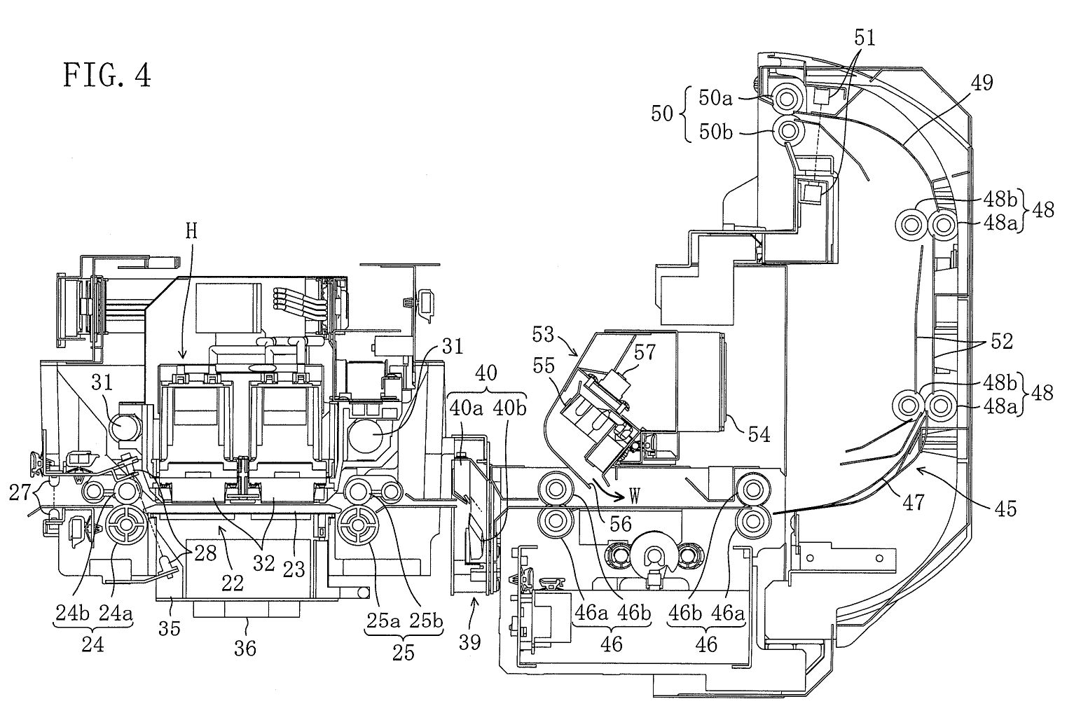

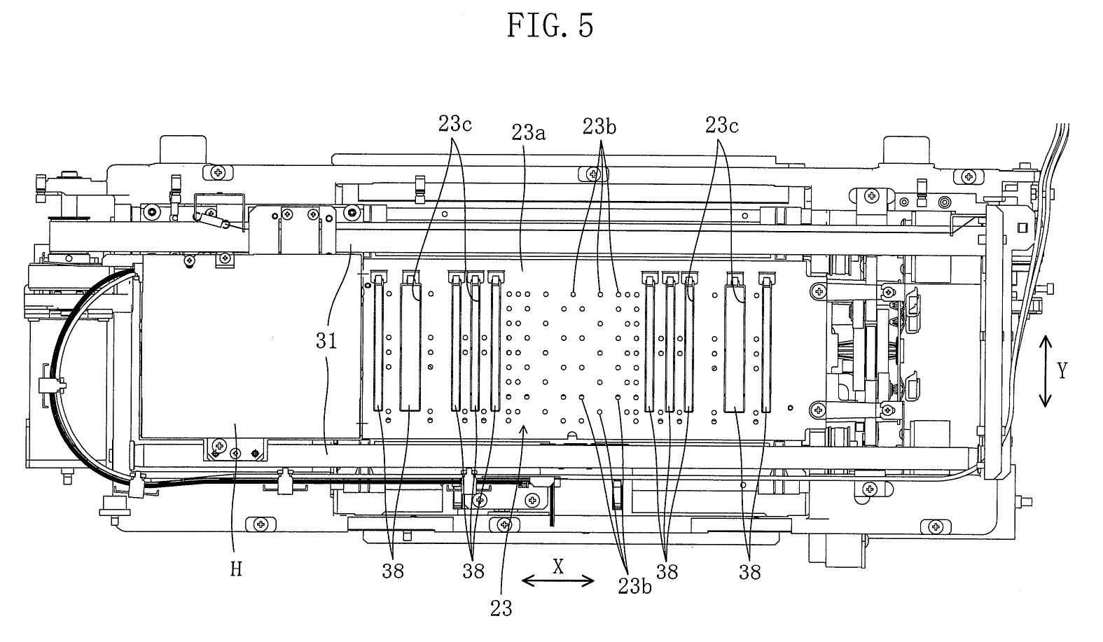

In the vicinity in the upper part of the housing 2 of the printer main body 1 where the cassette 5 is attached, the printing section 21 is provided which prints based on image data. The printing section 21 includes a print head H, a feeding section 22, and a platen 23, as show in detail in FIG. 4 and FIG. 5. The print head H prints on one side (upper side surface) of a media sheet P. The feeding section 22 substantially horizontally feeds the media sheet P supplied from the feed roller 14 to the side (the printer rear side) opposite to the side of the feed roller 14 in printing on the media sheet P. The platen 23 is opposed to the print head H, and supports the media sheet P fed by the feeding section 22.

There are disposed an upstream side roller pair 24 (corresponding to a pre-printing feeding section) of press-fit type at the upstream side end (printer front side end) of the feeding section 22, and a downstream side roller pair 25 (corresponding to post-printing feeding section) of press-fit type at the downstream side end (printer rear side end) of the feeding section 22. Lower drive rollers 24a, 25a of the upstream side roller pair 24 and the downstream side roller pair 25 are driven independently of each other for feeding the media sheet P. As will be described later in detail, upper driven rollers 24b, 25b of the upstream side roller pair 24 and the downstream side roller pair 25 are switched between a state where they are press-fit against the corresponding lower drive rollers 24a, 25a and a state the press-fit state is released.

On the upstream and downstream sides of the upstream roller pair 24, first and second sensors 27, 28, both of which include light projection portions and photodetectors, for detecting a media sheet P are provided with the upstream side roller pair 24 interposed. The first sensor 27 detects that the tip end of a media sheet P enters the housing 2 of the printer main body 1 from the cassette 5 or the duplex printing unit 7. Upon detection by the sensor 27, the drive roller 24a of the upstream side roller pair 24 is driven. The second sensor 28 detects the tip end of the media sheet P fed from the upstream side roller pair 24. When the upstream side roller pair 24 feeds, after detection of the tip end of the media sheet P by the second sensor 28, the media sheet P by an amount that allows a print start point of the media sheet P to reach a part below the print head H, printing on the media sheet P starts. Further, as will be described later in detail, when the upstream side roller pair 24 feeds, after detection of the tip end of the media sheet P by the second sensor 28, the media sheet P by an amount that allows the tip end of the media sheet P to reach the downstream side roller pair 25, the press-fit state of the upstream side roller pair 24 is changed to the press-fit released state, and the press-fit released state of the downstream side roller pair 25 is changed to the press-fit state. Then, the downstream side roller pair 25 feeds the media sheet P.

The print head H is configured to move along two guide rails 31 extending in a main scan direction X (see FIG. 5) agreeing with the width direction of a media sheet P (the printer transverse direction) above the media sheet P. The print head H includes two head units 32 arranged side by side in a sub scan direction Y (see FIG. 5) agreeing with the direction in which the media sheet P moves (the printer longitudinal direction), which is perpendicular to the main scan direction X. By downwardly ejecting ink in a plurality of colors from multiple ink ejection nozzles (not shown) provided at the lower surface of the two head units 32, a predetermined image can be printed on the upper surface of the media sheet P. In the present example embodiment, the two head units 32 are provided side by side in the sub scan direction Y. However, the number of head units is not limited to two, and may be one or three or more.

The print head H is made of LCP (liquid crystal polymer) excellent in heat resistance for suppressing adverse influence of thermal expansion. The distance between the two head unites 32 provided as above may vary due to temperature rise to cause printing misalignment. The print head H is made of LCP for preventing this phenomenon.

The head units 32 have the same configuration, and include a plurality of nozzle rows for ejecting ink in colors, which are arranged in the main scan direction X. In the nozzle rows, the aforementioned ink ejection nozzles are arranged in the sub scan direction Y. Accordingly, each head unit 32 can form a color image solely. The upstream side roller pair 24 and the downstream side roller pair 25 feed a media sheet P in the sub scan direction Y intermittently (step by step) by a given unit feeding amount. At each stop of the media sheet P in this intermittent feed, the print head H performs one scan (one one-way operation or one return operation) in the main scan direction X. During such one scan, the ink is ejected from the ink ejection nozzles in colors of the head units 32 at respective points in the main scan direction X onto the upper surface of the media sheet P. That is, after one scan by the print head H, the media sheet P is fed by the unit feeding amount. Then, the print head H performs one scan again. The above operation is repeated to print a desired image.

Here, as a configuration for ink ejection of the print head H in the present example embodiment, a general piezoelectric configuration may be employed in which the volume in a pressure chamber in which the ink is filled is changed by a piezoelectric element to cause the ink to be ejected from the ink ejection nozzles communicating with the pressure chamber.

The platen 23 is formed with a plate-shaped member, and has an upper surface serving as a support surface 23a supporting a media sheet P. Multiple suction holes 23b (see FIG. 5) opening in the support surface 23a are formed through the platen 23 in the thickness direction (vertical direction).

The suction holes 23b are arranged such that a plurality of rows of the suction holes, extending along a row direction (the main scan direction X) orthogonal to the feeding direction (the sub scan direction Y) in which the media sheet is fed, are arranged at intervals along the feeding direction.

As shown in FIG. 4, a casing 35 forming a space together with the platen 23 is disposed below the platen 23. A suction device 36 including a fan and the like is disposed below the casing 35. The suction holes 23b communicates with the space in the casing 35. This space communicates with the suction port of the suction device 36. When the suction device 36 is operated, negative pressure is generated on the support surface 23a of the platen 23 through the suction holes 23b, thereby allowing a media sheet P to be sucked to and held on the support surface 23a of the platen 23. This can ensure flatness of the media sheet P at printing to increase printing quality.

Further, recesses 23c (see FIG. 5) extending in the sub scan direction Y are formed in the support surface 23a of the platen 23 for housing ink absorbers 38. Part of the ink ejected from the print head H (the head units 32) may go beyond and outside the edges in the width direction of a media sheet P on the support surface 23a in borderless printing where an image is printed on the entire media sheet P. The ink absorbers 38 are provided for preventing a smear on the support surface 23a of the platen 23 by the ink having gone outside. Accordingly, the recesses 23c are formed at positions in the support surface 23a corresponding to the edge in the width direction of a media sheet P on the support surface 23a and corresponding to the print head H in the sub scan direction Y so as to extend along the edge (i.e., extend in the sub scan direction Y) in the support surface 23a. In the example shown in FIG. 5, the recesses 23c are formed five by five (ten in total) on the respective sides so as to address media sheets P having five different widths. The ink absorbers 38 are preferably in, for example, a sponge form excellent in ink absorption.

Here, in borderless printing, the ink is ejected to the absolute edges in the width direction of a media sheet P, and the ink absorbers 38 absorb the ink having gone beyond and outside the edge. On the other hand, the ink is not ejected to the absolute front edge and the absolute rear edge of the media sheet P with a predetermined amount (e.g., 2 mm) left as margins. Then, the margins are cut off by a cutter 40, which will be described later, to obtain a borderless image. The reason for doing so is as follows. If the ink is ejected toward the front edge and the rear edge of the media sheet P, the ink beyond them may be sucked into the suction holes 23b by suction through the suction holes 23b to degrade printing quality, and may cause the support surface 23a to be smeared with the ink.

On the downstream side of the feeding section 22 in the upper part of the housing 2 of the printer main body 1, a U-turn section 45 is provide which causes a media sheet P fed from the downstream side end (the downstream side roller pair 25) of the feeding section 22 to make a U-turn so that the media sheet P is flipped over and its feed direction is reversed.

On the upstream side of the U-turn section 45 and on the downstream side of the feeding section 22, a cutting section 39 is arranged. In borderless printing, the cutting section 39 substantially horizontally conveys the media sheet P printed by the printing section 21 and fed from the feeding section 22 as it is, and sequentially cuts the margins at the front edge part and the rear edge part for the media sheet P. In the cutting section 39, a cutter 40 is provided at the approximate center of the feed path for the media sheet P. The cutter 40 includes a fixed blade 40a (corresponding to an upper blade) and a movable blade 40b (corresponding to a lower blade). The fixed blade 40a is disposed so as to extend in the width direction of a media sheet P (the main scan direction X) on the upper side of the media sheet P feed path. The movable blade 40b is disposed so as to extend in the width direction of a media sheet P on the lower side of the media sheet P feed path, and is moved by a motor (not shown) vertically relative to the fixed cutter 40a. When a to-be-cut part of the media sheet P is positioned between the fixed blade 40a and the movable blade 40b, the movable blade 40b moves from bottom to top of the media sheet P with the fixed blade 40a fixed, thereby cutting the media sheet P. Chips formed by such cutting fall down and are housed in a chip box 41 (see FIG. 2) disposed below the cutter 40 in the lower part of the housing 2 after being blown upward of the feed path by the upwardly moving movable blade 40b. In the case of borderless printing on both sides of a media sheet P, the cutter 40 cuts the margins after printing on both sides thereof.

The U-turn section 45 includes two feed roller pairs 46 of press-fit type disposed on the upstream side of the U-turn section 45 and substantially horizontally feeding the media sheet P from the feeding section 22 further toward the printer rear side, a first direction changing member 47 (see FIG. 4) changing upward the feed direction of the media sheet P fed from the feed roller pairs 46, two feed roller pairs 48 of press-fit type disposed on the downstream side of the first direction changing member 47 and sandwiching and feeding upward the media sheet P, a second direction changing member 49 (see FIG. 4) changing the feed direction of the media sheet P fed from the feed roller pairs 48 toward the printer front side, a feed roller pair 50 of press-fit type disposed on the downstream side end of the U-turn section 45 and sandwiching the media sheet P and discharging it from the U-turn section 45, and a third sensor 51 (including a light projection portion and a photodetector) disposed in the vicinity of the feed roller pair 50 and detecting that the media sheet P is located at the position. Between the two feed roller pairs 48, a pair of guide plates 52 (see FIG. 4) are disposed so as to interpose the feed path. The guide plates 52 guides the tip end of the media sheet P sent from the lower feed roller pair 48 to the upper feed roller pair 48.

Between the two feed roller pairs 46 on the upstream side of the U-turn section 45, a dryer 53 that blows to the upper surface of the media sheet P dry wind W (see FIG. 4) for drying the ink adhering to the upper surface of a media sheet P in the printing section 21. The dryer 53 includes a suction fan 54 for taking air into the inside of the dryer 53, a heater 55 heating the air taken by the suction fan 54, an ejection nozzle section 56 opening to the lower end of the dryer 53 and blowing the air heated by the heater 55 as the dry wind W to the upper surface of the media sheet P, and a safety thermostat 57 detecting the temperature in the dryer 53 to urgently stop the heater 55.

In all the feed roller pairs 46, 48, 50 of the U-turn section 45, the rollers coming into contact with the surface opposite to the print surface of the media sheet P having received printing by the printing section 21 (lower rollers of the two feed roller pairs 46 on the upstream side, printer rear side rollers of the two feed roller pairs 48 on the downstream side of the feed roller pairs 46, and an upper roller of the feed roller pair 50) are drive rollers 46a, 48a, 50a. On the other hand, the rollers coming in contact with the print surface (upper rollers of the feed roller pairs 46, printer front side rollers of the feed roller pairs 48, and a lower roller of the feed roller pair 50) are driven rollers 46b, 48b, 50b. The driven rollers 46b, 48b, 50b are made of a material softer than the drive rollers 46a, 48a, 50a. For example, the drive rollers 46a, 48a, 50a are made of polypropylene, and the driven rollers 46b, 48b, 50b are made of urethane foam. When the driven rollers 46b, 48b, 50b coming into contact with the print surface are soft, the acceptable speed of the media sheet feed rate can be increased. Further, when the drive rollers 46a, 48a, 50a coming into contact with the surface opposite to the print surface are hard, accuracy of media sheet feed can be ensured. As a consequence, meandering and the like can hardly occurs.

All the drive rollers 46a, 48a, 50a are driven by the same motor (not shown). The rotational speed of the drive rollers 46a, 48a, 50a, that is, the media sheet feed rate by the feed roller pairs 46, 48, 50 is variable. The dryness of the ink by the dryer 53 varies depending on the environmental conditions (temperature, humidity, etc.) where the inkjet printer A is installed. Therefore, the feed rate is changed accordingly. Further, where the duplex printing unit 7 is attached to the printer main body 1, the ink is dried within the time when the duplex printing unit 7 feeds the media sheet P. Therefore, the feed rate is set at a comparatively high speed at which the ink may be incompletely dried by the dryer 53. By contrast, where the duplex printing unit 7 is not attached to the printer main body 1 (see FIG. 13), the media sheets P discharged from the U-turn section 45 by the feed roller pair 50 are directly discharged outside the body 2, and are placed and staked on the upper surface of the housing 2. Therefore, the feed rate is set at a comparatively low speed at which the ink can be completely dried by the dryer 53.

The third sensor 51 detects the rear end of a media sheet P for detecting discharge of the media sheet P from the U-turn section 45. Where the duplex printing unit 7 is not attached to the printer main body 1, the third sensor 51 detects discharge of a media sheet P from the housing 2. By contrast, where the duplex printing unit 7 is attached to the printer main body 1, when a media sheet P is fed by an amount that allows the rear end of a media sheet P to be apart from the feed roller pair 50 after detection of the rear end of the media sheet P, the media sheet P feed rate in the duplex printing unit 7 is changed (increased).

The duplex printing unit 7 has a two-part configuration of a first unit 8 covering the upper surface of the housing 2 and a second unit 9 located above the cassette 5. In the state where the duplex printing unit 7 is attached to the printer main body 1, only the first unit 8 can be detached from the housing 2. When the first unit 8 is detached, maintenance of the printing section 21 (especially, the print head H etc.) can be carried out through the maintenance opening (usually shut by a lid) formed in the upper surface of the housing 2. Accordingly, even after the duplex printing unit 7 is attached to the printer main body 1, maintenance of the printing section 21 can be carried out easily.

Within the first unit 8 of the duplex printing unit 7, a reverse feeding section 61 is provided which feeds the media sheet P sent out from the U-turn section 45 to the side of the cassette 5 (printer front side relative to the printing section 21) over the printing section 21. The reverse feeding section 61 includes three feed roller pairs 62 of press-fit type sandwiching a media sheet P and feeding it toward the printer front side, and a fourth sensor 63 (including a light projection portion and a photodetector) disposed at a position of the downstream side end (printer front side end of the first unit 8) of the reverse feeding section 61 and detecting that a media sheet P is located at the position.

The feed path in the reverse feeding section 61 is a straight path slightly inclined downward as it goes toward the printer front side. The reason that the inclination is provided is as follows. That is, the level of the feed roller pair 50 of the U-turn section 45 is needed to be high enough so that a sufficient number of media sheets P can be stacked on the upper surface of the housing 2 where the media sheets P are placed in the case where the duplex printing unit 7 is not attached to the printer main body 1. On the other hand, in a switchback section 66 in the second unit 9, which will be described later, it is preferable to reduce as far as possible the number of supply roller pairs 69, which will be described later, supplying a switched-back media sheet P to the upstream side end of the feeding section 22 with the relationship with the minimum length of the media sheet P taken into consideration. To do so, it is necessary to dispose the switchback section 66 at a level close to the feeding section 22. Therefore, the feed path in the reverse feeding section 61 which connects the U-turn section 45 to the switchback section 66 is inclined as above.

Of all the feed roller pairs 62 of the reverse feeding section 61, rollers (upper rollers) coming into contact with the surface of a media sheet P opposite to the print surface printed by the printing section 21 are drive rollers 62a. Rollers (lower rollers) coming into contact with the print surface are driven rollers 62b. Similarly to the feed roller pairs 46, 48, 50 of the U-turn section 45, the driven rollers 62b are made of a material softer than the drive rollers 62a.

All the drive rollers 62a are driven by the same motor (not shown). The rotational speed of the drive rollers 62a, that is, the media sheet feed rate by the feed roller pairs 62 is variable, similarly to the drive rollers 46a, 48a, 50a of the feed roller pairs 46, 48, 50 of the U-turn section 45. As described above, the feed rate is increased when a media sheet P is fed by an amount that allows the rear end of the media sheet P to be apart from the feed roller pair 50 after detection of the rear end of the media sheet P by the third sensor 51. Specifically, since the feed path of the U-turn section 45 is curved, the feed rate must be set at a speed at which a media sheet P can be fed stably without damaging the print surface. Further, in the state where the rear end of a media sheet P is located on the upstream side of the feed roller pair 50, the media sheet feed rate by the feed roller pairs 62 must be set at the same speed as the feed rate in the U-turn section 45. However, when the rear end of the media sheet P goes beyond the feed roller pair 50, the media sheet P is fed in the straight feed path to increase the acceptable speed. Thus, the feed rate is increased. It is noted that the feed rate is adjusted according to the status of the other media sheets P (the number and position of existing media sheets P) existing on the downstream side of the media sheet P for which the feed rate is to be increased.

In the second unit 9, the switchback section 66 is provided which switches back the media sheet P fed from the reverse feeding section 61 and supplies it from its rear end to the upstream side end of the feeding section 22. The switchback section 66 includes a switchback roller pair 67 of press-fit type, a pair of first guide members 68, a supply roller pair 69 of press-fit type, and a pair of second guide members 70. The switchback roller pair 67 includes a lower drive roller 67a and an upper driven roller 67b. The first guide members 68 are provided so as to interpose the feed path on the upstream side of the switchback roller pair 67, and guide the media sheet P fed from the reverse feeding section 61 to the switchback roller pair 67. The supply roller pair 69 supplies the switched-back media sheet P to the upstream side end of the feeding section 22. The second guide members 70 are provided so as to interpose the feed path between the switchback roller pair 67 and the supply roller pair 69, and guide the switched-back media sheet P to the supply roller pair 69.

The drive roller 67a of the switchback roller pair 67 is capable of rotating, by a motor (not shown) in forward direction for sandwiching a media sheet P in combination with the driven roller 67b and feeding it toward the printer front side, and in reverse direction for sandwiching the media sheet P in combination with the driven roller 67b and feeding it toward the printer rear side.

The switchback roller pair 67 and the first guide members 68 are integrally rotated by the motor (not shown) about the rotation axis of the drive roller 67a of the switchback roller pair 67. This enable the driven roller 67b of the switchback roller pair 67 to be switched between a first position (see FIG. 6) where it is located substantially right above the drive roller 67a and a second position (see FIG. 7) where it is located on the printer rear side of the drive roller 67a. The first guide members 68 are located on the extension of the feed path in the reverse feeding section 61 (see FIG. 6) when the driven roller 67b is at the first position, and are located on the extension of the second guide members 70 (see FIG. 7) when the driven roller 67b is at the second position.

Here, a method for switching back the media sheet P fed from the reverse feeding section 61 will be described. At the time when the switchback roller pair 67 receives the media sheet P fed from the reverse feeding section 61, the driven roller 67a is rotated in the forward direction, and the driven roller 67b is set at the first position. When the switchback roller pair 67 feeds the media sheet P toward the printer front side by an amount that allows the rear end of the media sheet P to be located at the first guide members 68 (see FIG. 6) after the fourth sensor 63 detects the rear end, the forward rotation of the drive roller 67a is stopped. At this time, at least the front end part of the media sheet P is located above a placement tray 74, which will be described later.

Subsequently, the switchback roller pair 67 and the first guide members 68 are rotated in the clockwise direction in FIG. 6 to switch the driven roller 67b from the first position to the second position. This raises the front end part (printer front side) of the media sheet P to curve the media sheet P and allow it to come into contact with two auxiliary rollers 72 disposed above the switchback roller pair 67 on the printer front side (see FIG. 7).

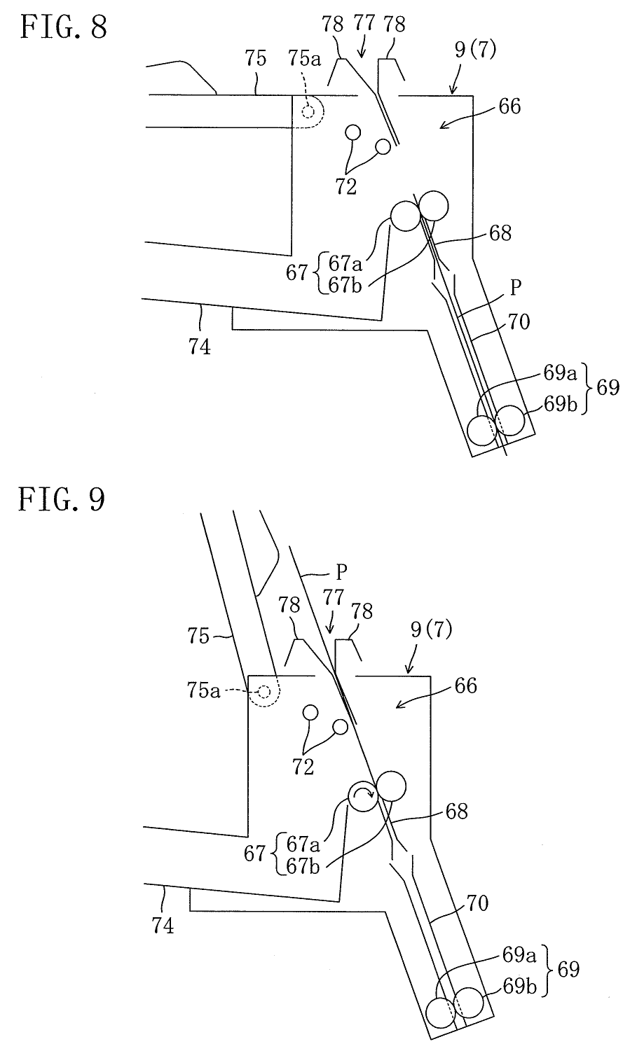

Thereafter, the drive roller 67a is rotated in the reverse direction to feed the media sheet P from its rear end to the supply roller pair 69. At this time, the auxiliary rollers 72 rotates accompanied by feed of the media sheet P. Therefore, the rear end part of the switched-back media sheet P (corresponding to the front end part in the forward rotation of the drive roller 67a) can be moved smoothly, and is not rubbed with the inner wall surface and the like of the second unit 9, thereby receiving no damage. The media sheet P switched back by the switchback roller pair 67 passes in the first guide members 68 and the second guide members 70 to reach the supply roller pair 69 (see FIG. 8).

The supply roller pair 69 includes a drive roller 69a driven by a motor (not shown) and a driven roller 69b press-fit against the drive roller 69a. The press-fit state of the driven roller 69b against the drive roller 69a can be released as will be described later. The same is applied to the driven roller 67b of the switchback roller pair 67.

Below the supply roller pair 69, a pair of third guide members 73 are disposed so as to interpose the feed path. A media sheet P is supplied through the third guide members 73 to the upstream side end of the feeding section 22. The upper surface of the media sheet P thus supplied to the feeding section 22 through the duplex printing unit 7 is the surface (hereinafter referred to as a reverse surface) opposite to the surface (hereinafter referred to as an obverse surface) of the media sheet P printed first by the printing section 21, and is not yet printed. Printing on the reverse surface similar to the first printing results in printing on both sides of the media sheet P.

The switchback roller pair 67 also serves for discharging the media sheet P fed by the reverse feeding section 61 outside the second unit 9 without switching it back. In other words, the switchback roller pair 67 continues to rotate the drive roller 67a in the forward direction without stop in the middle for discharging the media sheet P outside the second unit 9. The placement tray 74 which receives and places the media sheet P sent out from the switchback roller pair 67 is provided at the surface on the printer front side of the outer wall of the second unit 9. A media sheet P having received duplex printing as described above and/or a media sheet P having received simplex printing on only their obverse surfaces is/are discharged outside the second unit 9 by the switchback roller pair 67, and then are placed on the placement tray 74.

Above the placement tray 74, a covering member 75 for preventing dust and the like from adhering to the media sheet P placed on the placement tray 74 is supported at its one side on the surface on the printer front side of the outer wall of the second unit 9 so as to cover the placement tray 74. The covering member 75 is pivotally supported at its base end (printer rear side end) about an axis 75a (see FIGS. 6 to 9) extending in the printer transverse direction. Therefore, the covering member 75 can stand so as to extend upward from the base end by being rotated about the axis 75a (see FIG. 9).

In the vicinity of the switchback roller pair 67, a manual paper feed opening 77 through which a media sheet P can be fed and inserted manually is formed in the upper surface of the outer wall of the second unit 9. At the manual paper feed opening 77, a pair of manual paper feed guide members 78 are disposed so as to interpose a manually fed and inserted media sheet P in the thickness direction. The manual paper feed guide members 78 guides the tip end of the manually fed and inserted media sheet P to the switchback roller pair 67. Further, the manual paper feed opening 77 is covered with a lid 79 (see FIG. 1). In order for the operator to feed and insert a media sheet P, the operator opens the lid 79, and operates a mode switch (not shown) to switch the switch mode to a manual feed mode. This switches the driven roller 67b of the switchback roller pair 67 to the second position, and causes the drive roller 67a to rotate in the reverse direction. Then, the operator inserts a media sheet P from the manual paper feed opening 77. At this time, if the covering member 75 stands, it can serve as a receiver for supporting the media sheet P, thereby facilitating insertion of the media sheet P. When the media sheet P is inserted from the manual paper feed opening 77 in this way, the media sheet P is fed by the switchback roller pair 67 to the supply roller pair 69, and then is supplied to the feeding section 22 (printing section 21) by the supply roller pair 69, similarly to the switched-back and fed media sheet P.

As shown in FIG. 10, the switchback section 66 includes a correction mechanism 81 which corrects the position in the width direction of the media sheet P supplied to the feeding section 22. The correction mechanism 81 includes, on the respective printer transverse sides of the second guide members 70, a pair of right and left upper release levers 82, a pair of right and left lower release levers 83, and a pair of right and left width restricting members 84, 85. The upper release levers 82 set the driven roller 67b of the switchback roller pair 67 to be in a press-fit released state. The lower release levers 83 set the driven roller 69b of the supply roller 69 to be in a press-fit released state. The width restricting members 84, 85 come into contact with respective side ends in the width direction of the media sheet P.

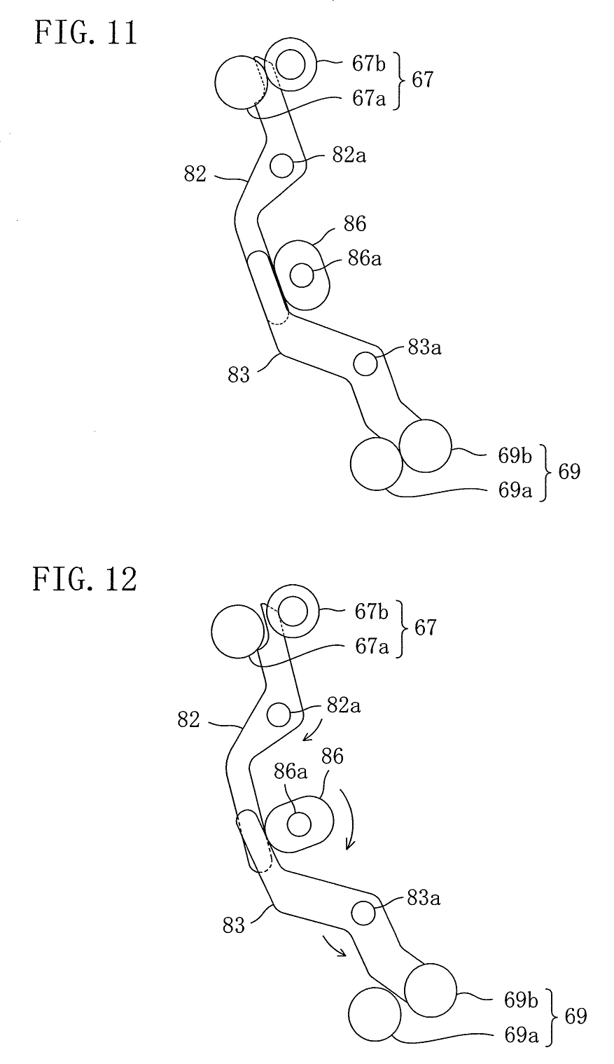

As shown in FIG. 11, the upper release levers 82 and the lower release levers 83 are pivotable about axes 82a, 83a extending in the printer transverse direction, respectively. One end of each upper release lever 82 is located in the vicinity of the axial end of the driven roller 67b in the press-fit state when the switchback roller 67 is set at the second position. The other end of each upper release lever 82 is in contact with the cam surface of a release cam 86 supported by an axis 86a extending in the printer transverse direction. One end of each lower release lever 83 is coupled to the axial end of the driven roller 69b of the supply roller pair 69. The other end of each lower release lever 83 is in contact with the cam surface of the release cam 86.

The release cam 86 is rotated by a motor (not shown) together with its axis 86a. As shown in FIG. 12, rotation of the release cam 86 by 90° rotates the upper release levers 82 about the axis 82a in the clockwise direction in FIG. 12 to set the driven roller 67b of the switchback roller pair 67 to be in the press-fit released state, and rotates the lower release levers 83 about the axis 83a in the anticlockwise direction in FIG. 12 to set the driven roller 69b of the supply roller pair 69 to be in the press-fit released state. Then, rotation of the release cam 86 further by 90° sets the driven rollers 67b, 69b of the switchback roller pair 67 and the supply roller pair 69 to be in the press-fit states. Accordingly, the upper release levers 82, the lower release levers 83, and the release cam 86 configure a switching mechanism for switching the switchback roller pair 67 and the supply roller pair 69 between the press-fit states and the press-fit released states.

The width restricting members 84, 85 are positioned by the operator's operation at positions corresponding to the width of a to-be-printed media sheet P, as described above.

Specifically, the width restricting members 84, 85 are located at the positions where they come into contact with the side ends in the width direction of a to-be-printed media sheet P. The width restricting members 84, 85 are bent so as to form rectangular grooves opening toward the surfaces opposed to each other. The bottoms of the grooves come into contact with the side ends in the width direction of a media sheet P. It is noted that the upstream side parts of the bottoms of the grooves are inclined outward in the width direction of the feed path as they go upstream so as to guide a media sheet P into the grooves.

One 84 (left hand in FIG. 10) of the width restricting members 84, 85 is configured to move in the width direction of a media sheet P by a predetermined amount with a distance left from the position positioned by the operator's operation, and receives spring force so as to approach the other width restricting member 85 (right hand in FIG. 10). The width restricting member 85 is fixed at a position positioned by the operator's operation. The spring force of the width restricting member 84 pushes a media sheet P toward the width restricting member 85 to allow the end of the media sheet P on the side of the width restricting member 85 to come in contact with the width restricting member 85. The width restricting member 85 is disposed so that the position of the media sheet P at this time is a reference position in the width direction of the feed path.

However, the spring force of the width restricting member 84 is comparatively small. Accordingly, during the time when the switchback roller pair 67 or the switchback roller pair 67 and the supply roller pair 69 feed(s) a media sheet P, the feeding force of the roller pairs 67, 69 overpowers the spring force of the width restricting member 84. Therefore, the width restricting member 84 cannot push the media sheet P toward the width restricting member 85. In other words, the spring force of the width restricting member 84 is set at a value at which a media sheet P can be moved in its width direction when the switching mechanism switches the driven rollers 67b, 69b of the switch back roller pair 67 and the supply roller pair 69 to the press-fit released state. For this reason, during feed of a media sheet P, the width restricting member 84 cannot correct the position in the width direction of the media sheet P, and moves in the width direction of the media sheet P in association with meandering of the media sheet P. As a result, the media sheet P tends to be displaced left in FIG. 10 from the reference position.

In view of this, the correction mechanism 81 switches the driven rollers 67b, 69b of the switchback roller pair 67 and the supply roller pair 69 to the press-fit released states to move a media sheet P toward the width restricting member 85 by the spring force of the width restricting member 84, thereby correcting the position in the width direction of the media sheet P relative to the feed path. Specifically, when the tip end of a media sheet P reaches a predetermined point (e.g., slightly downstream side of the supply roller pair 69), feed of the media sheet P by the switchback roller pair 67 and the supply roller pair 69 stops. Then, the switching mechanism sets the driven rollers 67b, 69b of the switchback roller pair 67 and the supply roller pair 69 to the press-fit released states. This makes the media sheet P free to move the media sheet P toward the width restricting member 85 by the spring force of the width restricting member 84, thereby accurately aligning the media sheet P to the reference position in the width direction of the feed path. Thus, the position in the width direction of the media sheet P relative to the feed path can be corrected. Also, the posture (inclination) of the media sheet P relative to the feed path can be corrected to the proper posture. After a predetermined period (a period until correction by moving the media sheet P by the spring force of the width restricting member 84 completes) elapses from the time when the press-fit released state is set, a switching mechanism sets the driven rollers 67b, 69b of the switchback roller pair 67 and the supply roller pair 69 to the press-fit states. Then, the switchback roller pair 67 and the supply roller pair 69 start feeding the media sheet P.

The above described correction is performed once or plural times on the same media sheet P. In the case where it is performed plural times, when a media sheet P is fed by a predetermined amount from feed restart, the feed is stopped again to repeat the same correction as above. The number of times of correction performed is determined according to the characteristics of a media sheet P (dimensional characteristics, such as length, thickness, etc., material characteristics, such as hardness, surface quality (glossy and matte), etc.). For example, as the length of a media sheet P (determined by the information on size of the media sheet P input by the operators, as described above) increases, the number of times of correction is increased, thereby correcting the position in the width direction of the media sheet P over its entire length. Further, if a media sheet P is hard to be moved in the width direction depending on the thickness, hardness, and the like of the media sheet P (of which information is input by the operator, or stored in and read from an IC chip provided in the cassette 5, as described above), the number of times of correction is increased accordingly. It is preferable to change the positions where a media sheet P is stepped for correction (i.e., the aforementioned predetermined position and predetermined amount) according to the number of times of correction.

Rather than by the spring force of the width restricting member 84, the width restricting member 84 may be moved by, for example, an actuator (a driving device, such as a motor) and a movement limiting device (a torque limiter etc.). Alternatively, both the width restricting members 84, 85 may be moved by a force applying member, such as a spring, or by an actuator and a movement limiting device.

Thus, a media sheet P is supplied to the feeding section 22 (printing section 21) with it accurately aligned to the reference position in the width direction of the feed path to allow the printing section 21 to stably print at the appropriate position on a media sheet P, thereby improving printing quality.

The U-turn section 45, the reverse feeding section 61, and the switchback section 66 configure a media sheet re-supply section 88 which connects the downstream side end to the upstream side end of the feeding section 22 to form an orbit feed path surrounding the print head H together with the feeding section 22, and which flips over the media sheet P sent out from the downstream side end of the feeding section 22 whose obverse surface has received printing, and supplies it to the upstream side end of the feeding section 22. By the media sheet re-supply section 88, a media sheet P whose obverse surface has received printing can be flipped over and supplied again to the printing section 21. Printing on the reverse surface of this media sheet P results in printing on both sides of the media sheet P.

The U-turn section 45 and the reverse feeding section 61 feed to the switchback section 66 the media sheet P whose reverse surface has received printing, similarly to the feed after the obverse surface of the media sheet P receives printing (first feed of the media sheet P). At this time, the switchback roller pair 67 of the switchback section 66 continues to rotate in the forward direction, thereby discharging the media sheet P onto the placement tray 74. It is noted that, when the U-turn section 45 and the reverse feeding section 61 feed the media sheet P whose reverse surface has received printing, the drive rollers 46a, 48a, 50a, 62a of the feed rollers 46, 48, 50, 62 come into contact with the obverse surface of the media sheet P. However, since the ink adhering to the obverse surface is completely dried at this time point, the media sheet P can be fed at the same feed rate as that at the first feed. Nevertheless, the feed rate at the second feed may be set lower than that of the first feed for further increasing printing quality.

The length of the feed path of the media sheet re-supply section 88 is set to be capable of holding, during printing on a current media sheet P by the printing section 21, at least one preceding media sheet P having received printing prior to the current media sheet P. Accordingly, the time between printing on the obverse surface of one media sheet P and printing on its reverse surface can be utilized for printing on at least one successive media sheet P.

For example, in the case of duplex printing on the smallest media sheet P of those in the plural types of sizes, first to fourth media sheets P are supplied in series from the cassette 5 to the printing section 21, and the printing section 21 successively prints on their obverse surfaces. When the fourth media sheet P is being printed, the three media sheets P having received printing are located at any parts of the media sheet re-supply section 88 (usually, the first media sheet P, the second media sheet P, and the third media sheet P are located at the switchback section 66, the reverse feeding section 61, and the U-turn section 45, respectively). When printing on the fourth media sheet P terminates, the first media sheet P whose obverse surface has received printing is supplied to the printing section 21 next for printing on the reverse surface of the first media sheet P. Subsequently, the reverse surfaces of the second to fourth media sheets P are successively printed (subsequent to this printing, the cutter 40 cuts the front end parts and the rear end parts of the media sheets P). When the reverse surface of the fourth media sheet P is being printed, the first media sheet P is discharged onto the placement tray 74 by the switchback roller pair 67, and the second and the third media sheets P are located at the reverse feeding section 61 and the U-turn section 45, respectively.

When printing on the fourth media sheet P terminates, fifth to eighth media sheets P are supplied in series from the cassette 5 to the printing section 21 next. Then, the printing section 21 successively prints on the obverse surfaces of the media sheets P. Thus, the obverse surfaces and the reverse surfaces of sets of four media sheets P are sequentially printed. It is noted that a set of media sheets P for simplex printing can be interposed between two sets for duplex printing.

Thus, in the present example embodiment, in the case of duplex printing on only one media sheet P, the reverse surface of the media sheet P is printed after the media sheet P whose obverse surface has received printing passes through the long feed path of the media sheet re-supply section 88, thereby lengthening the processing time. By contrast, in the case of duplex printing on a predetermined number or more of media sheets P for business purpose or the like, the media sheet re-supply section 88 enables printing on another media sheet P during feed of at least one media sheet P, thereby increasing printing capacity. Further, the ink adhering to the obverse surface of a media sheet P in the printing section 21 can be sufficiently dried during the time until the reverse surface is printed. Printing on the reverse surface in such a dried state prevents both sides of the media sheet P from being simultaneously wet by the ink, thereby ensuring prevention of strike through and the like caused by ink penetration. In addition, media sheets P are hard to be curled and waved, thereby preventing degradation of printing quality of media sheets P.

A configuration of the feeding section 22 will be described next in detail.

Feed accuracy of the feeding section 22 significantly influences printing quality. Therefore, in the inkjet printer, the feeding section 22 is required to have especially high feed accuracy. However, in consecutive printing on plural media sheets P as above, a space is formed between any two consecutive media sheets P. Accordingly, when the media sheets P are sucked and held in the platen 23, the suction holes 23b located at the space are opened and suck much air on the side of the support surface 23a. This may cause ink suction, printing displacement, smears, and the like to degrade printing quality.

In view of this, the present example embodiment is devised so that the aforementioned space (i.e., a feed interval between the two consecutive media sheets P) is minimized when media sheets P are fed stably in consecutive printing on the media sheets P. In detail, a first drive mechanism 101 driving the upstream side roller pair 24 as the pre-printing feeding section provided on the upstream side of platen 23 and a second drive mechanism 102 driving the downstream side roller pair 25 as the post-printing feeding section provided on the downstream side of the platen 23 are driven and controlled independently of each other for feeding media sheets P. Further, when the rear end of a preceding media sheet P (hereinafter referred to as a preceding sheet P2) and the front end of a succeeding media sheet P (hereinafter referred to as a subsequent sheet P1) of any two consecutive media sheets P are located between the upstream side roller pair 24 and the downstream side roller pair 25 in consecutive printing on the media sheets P, the upstream side roller pair 24 performs follow-up feed in which the subsequent sheet P1 follows the preceding sheet P2 at a predetermined interval.

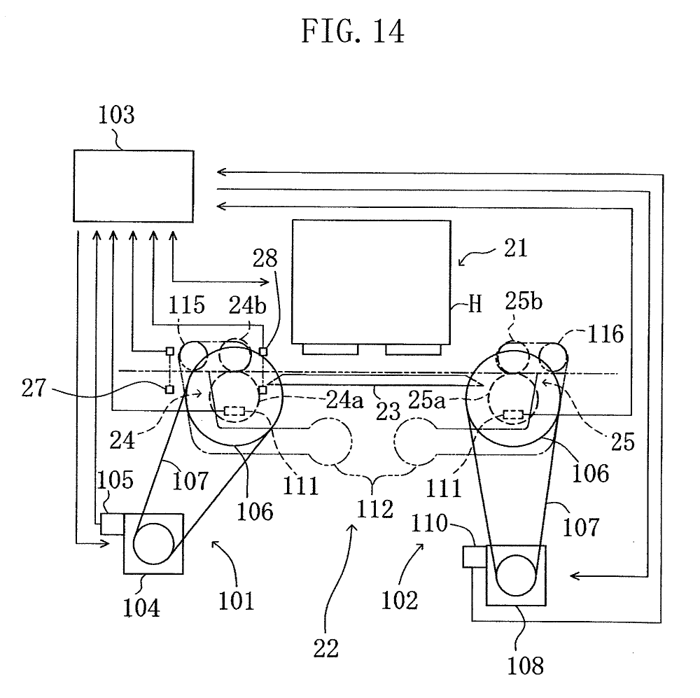

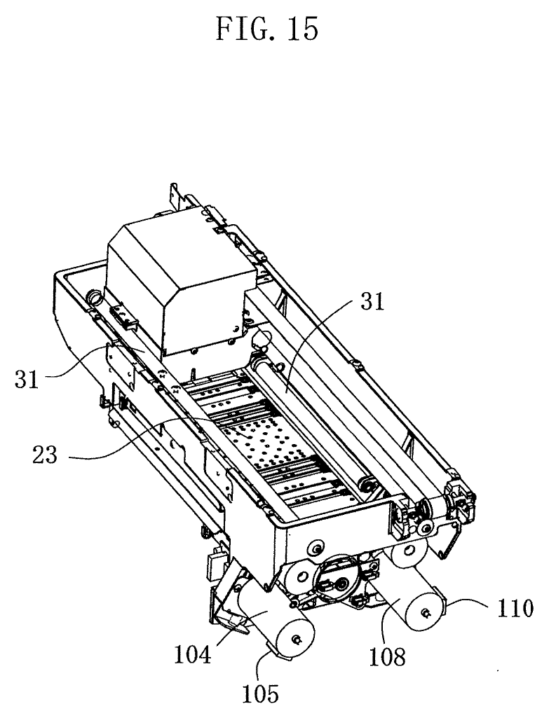

As shown in FIG. 14, the feeding section 22 includes the first drive mechanism 101, the second mechanism 102, a feeding control section 103, and a transfer mechanism. The first drive mechanism 101 drives the upstream side roller pair 24 for supplying a media sheet P onto the support surface 23a of the platen 23. The second drive mechanism 102 drives the downstream side roller pair 25 for discharging the media sheet P from the support surface 23a of the platen 23 and feeding it to the cutter 40. The feeding control section 103 controls the first drive mechanism 101 and the second drive mechanism 102.

The first drive mechanism 101 includes a first motor 104 driving the upstream side roller pair 24 (the drive roller 24a). The first motor 104 includes a first rotary encoder 105 detecting the rotation angle of the first motor 104. The drive roller 24a of the upstream side roller pair 24 is coupled to the first motor 104 through a transmission mechanism including a sprocket wheel 106 and a belt 107. The first motor 104 drives and rotates the drive roller 24a. From a detection value by the first rotary encoder 105, the amount of rotation of the first motor 104, that is, a feed amount of a media sheet P by the upstream side roller pair 24 can be obtained.

The second drive mechanism 102 includes a second motor 108 driving the downstream side roller pair 25 (the drive roller 25a). The second motor 108 includes a second rotary encoder 110 detecting the rotation angle of the second motor 108. The drive roller 25a of the downstream side roller pair 25 is coupled as well to the second motor 108 through a similar transmission mechanism for driving the drive roller 24a. From a detection value by the second rotary encoder 110, the amount of rotation of the second motor 108, that is, a feed amount of a media sheet P by the downstream side roller pair 25 can be obtained. It is noted that the first and second rotary encoders 105, 110 can detect the rotational speeds of the first and second motors 104, 108, respectively, according to time variations of the rotation angles.

Temperature sensors 111 which directly measure the roller temperatures (the temperatures of the drive rollers 24a, 25a in the present example embodiment) are mounted to the upstream side and downstream side roller pairs 24, 25. Since the temperature sensors 111 enable measurement of the roller temperatures, feeding error caused due to variation in roller temperatures can be corrected. Accordingly, even if the roller temperatures vary by long term driving of the upstream side and downstream side roller pairs 24, 25, printing quality can be prevented from being lowered. As a consequence, stable printing quality can be achieved even in consecutive printing on a plurality of media sheets P as in business use and the like.

The feeding control section 103 is a processing unit including a readily available CPU, ROM, RAM, and the like, and includes software for performing predetermined control. The feeding control section 103 performs temperature compensation control for correcting the outputs of the motors 104, 108 on the basis of, for example, the measurement values input from the temperature sensors 111 so as to keep the state of the media sheet P being fed by the upstream side and downstream side roller pairs 24, 25 constant regardless of the roller temperatures. Further, the feeding control section 103 performs transfer control and media sheet follow-up control, which will be described later.

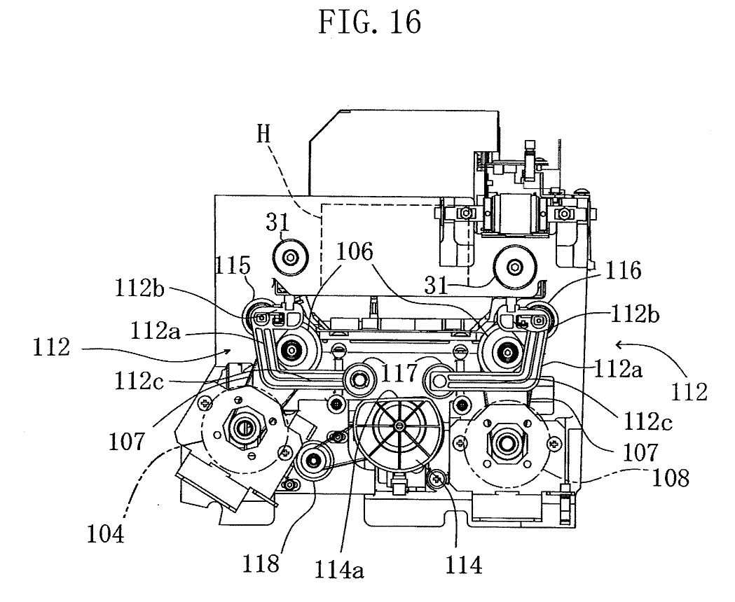

As shown in FIGS. 14 and 16, the transfer mechanism includes a pair of arms 112 and a cam member 114. Each of the arms 112 includes an arm base portion 112a, a roller receiving portion 112b, and a cam engaging portion 112c. The base end part of the arm base portion 112a is pivotally supported about an axis 115 (or an axis 116) extending in the printer transverse direction. The roller receiving portion 112b continues from the base end of the arm base portion 112a, and extends orthogonally to the arm base portion 112a. The cam engaging portion 112c continues from the tip end of the arm base portion 112a, and extends so as to be opposed to the roller receiving portion 112b. The cam engaging portion 112c is formed sufficiently longer than the roller receiving portion 112b. Thus, the arms 112 have outer appearances substantially in an L-shape. The arms 112 are arranged so that the tip ends of the cam engaging portions 112c are opposed to each other. The tip ends of the cam engaging portions 112c are urged downward by springs (not shown). The driven rollers 24b, 25b are pivotally supported at the tip ends of the roller receiving portions 112b. At the tip ends of the cam engaging portions 112c, cam engaging rollers 117 engaging with the cam member 114 are pivotally supported.

The cam member 114 is formed with a roller member having a comparatively large diameter and including a notch 114a formed by cutting a part of its peripheral part. The cam member 114 is arranged below and between the cam engaging rollers 117 so as to be capable of being in contact with both the cam engaging rollers 117. The cam member 114 is pivotally supported about an axis (not shown) extending in the printer transverse direction, and is driven and rotated by a motor 118 through a transmission mechanism. The feeding control section 103 controls the operation of the motor 118.

In the state where the notch 114a of the cam member 114 is positioned up as shown in FIG. 16, and is out of contact with the cam engaging rollers 117 of the arms 112, the spring force of the springs urging the arms 112 causes the driven rollers 24b, 25b supported by the roller receiving portions 112b to be press fit to the drive rollers 24a, 25a, respectively. At this time, the cam engaging portions 112c of the arms 112 are located substantially horizontally as if they extend on a single straight line.

When the cam member 114 rotates to be in contact at anywhere of its peripheral part with the cam engaging rollers 117 of the arms 112, the arms 112 rotate against the springs in the direction where the tip ends of the cam engaging portions 112c go upward. Accordingly, both or one of the driven rollers 24b, 25b are/is in a state(s) (a press-fit released state(s)) in which they/it are/is separated from the drive roller(s) 24a, 25a.

By switching between the press fit states and the press-fit released states of the driven rollers 24b, 25b, transfer of a media sheet p (switching of the roller pairs feeding a media sheet P), which will be described later, is performed. For this transfer, the feeding control section 103 performs the transfer control on the basis of information detected by the first sensor 27 and the second sensor 28.

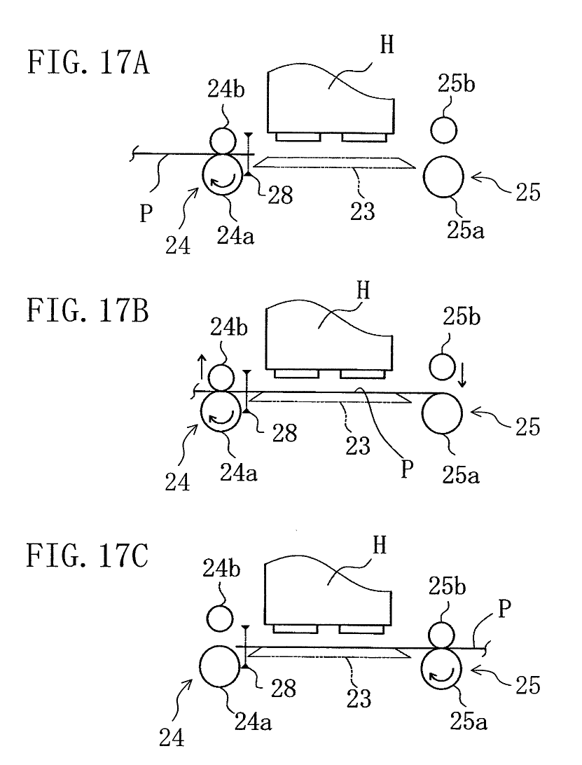

FIGS. 17A to 17C schematically show operation under the transfer control. First, when the first sensor 27 detects entering of the front end of a media sheet P into a housing 2 of the printer main body 1, the drive roller 24a is driven in the press fit state of the upstream side roller pair 24. Then, the upstream side roller pair 24 feeds the media sheet P toward the platen 23. At this time, the downstream side roller pair 25 is in the press-fit released state (see FIG. 17A). Next, when the second sensor 28 detects the front end of the media sheet P, the feeding control section 103 calculates timing when the front end of the media sheet P reaches the downstream side roller pair 25. Then, at the timing when the front end of the media sheet P reaches the downstream side roller pair 25, the feeding control section 103 rotates the cam member 114 to release the press fit state of the upstream side roller pair 24 while at the same time setting the downstream side roller pair 25 to be in the press fit state (see FIG. 17B). Thereafter, the drive roller 25a of the downstream side roller pair 25 is driven. Next, as shown in FIG. 17C, the media sheet P is transferred from the upstream side roller pair 24 to the downstream side roller pair 25, thereby feeding out the media sheet P from the platen 23 to the cutter 40.

The upstream side roller pair 24 in the press-fit released state is set to the press fit state within the time when the front end of the next media sheet P reaches the upstream side roller pair 24. Accordingly, when the rear end of the preceding sheet P2 and the front end of the subsequent sheet P1 of any two consecutive media sheets P are located between the upstream side roller pair 24 and the downstream side roller pair 25 in consecutive printing on the media sheets P, both the upstream side and downstream side roller pairs 24, 25 are in the press fit states.

By contrast, the downstream side roller pair 25 in the press fit state is set to the press-fit released state when feeding of the first media sheet P (the preceding sheet P2) terminates. When the front end of the next media sheet P (the subsequent sheet P1) reaches the downstream side roller pair 25, the downstream side roller pair 25 is set to the press fit state at or near the same time as the time when the upstream side roller pair 24 is set to the press-fit released state, similarly to the above.

The transfer control of transfer from the upstream side roller pair 24 to the downstream side roller pair 25 for feeding a media sheet P is performed because of the following causes. In a state where both the roller pairs 24, 25 simultaneously feed a single media sheet P, differences in feeding force and feeding amount of the roller pairs 24, 25 may excessively pull the media sheet P and distort it to cause a printing deficiency. Therefore, by the transfer control by the transfer mechanism and the feeding control section 103, the roller pairs 24, 25 can be prevented from simultaneously feeding a media sheet P, thereby stably obtaining high quality image.

In the present example embodiment, the feeding control section 103 performs media sheet follow-up control so as to achieve stable high printing quality and improve printing performance. The media sheet follow-up control is control of follow-up feed by the upstream side roller pair 24 when the rear end of the preceding sheet P2 and the front end of the subsequent sheet P1 of any two consecutive media sheets P are located between the upstream side roller pair 24 and the downstream side roller pair 25 in consecutive printing on the media sheets P. This follow-up feed is performed in a manner that the feeding control section 103 controls driving of the first motor 104 on the basis of detection values (rotation angles and/or rotational speeds) of the first rotary encoder 105 and the second rotary encoder 110, timing when the tip ends of the respective media sheets P are detected, which is output from the second sensor 28, scan timing of the printer head H, and the like.

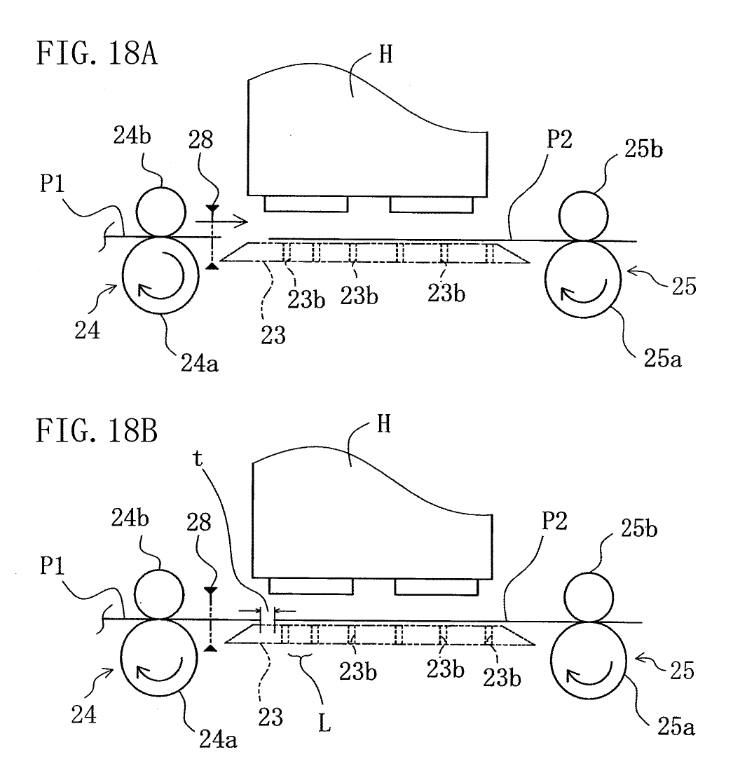

Specifically, as shown in FIG. 18A, when the front end of the subsequent sheet P1 subsequent to the preceding sheet P2 reaches the upstream side roller pair 24 in printing in which the downstream side roller pair 25 intermittently feeds the preceding sheet P2 at a given unit feed rate, the upstream side roller pair 24 feeds the subsequent sheet P1 toward the platen 23.

Next, when the second sensor 28 detects the front end of the preceding sheet P2, the feeding control section 103 controls the first motor 104 on the basis of the detection value of the first rotary encoder 105 to precisely control the feeding amount of the subsequent sheet P2. At this time, the feeding control section 103 also precisely controls the feeding amount of the preceding sheet P2 on the basis of the detection value of the second rotary encoder 110. Therefore, the media sheet follow-up control can be performed easily. Specifically, the feeding control section 103 controls the first motor 104, as shown in FIG. 18B, so that the front end of the subsequent sheet P1 reaches a point a predetermined interval t behind the rear end of the preceding sheet P2. Since the preceding sheet P2 is being fed intermittently, the subsequent sheet P1 can catch up with the preceding sheet P2 soon.

Thereafter, the upstream side roller pair 24 feeds the subsequent sheet P1 according to the feed rate of the preceding sheet P2 with the predetermined interval t kept unchanged. It is noted that the subsequent sheet P1 may follow the preceding sheet P2 as far as the predetermined interval t can be kept. For example, the predetermined interval t may be once increased and then be returned to the original value according to the printing state of the preceding sheet P2.

Here, it is preferable that the predetermined interval t is larger than 1 mm and smaller than a minimum interval L (see FIG. 18B) between any adjoining suction hole rows. If the predetermined interval is smaller than 1 mm, the rear end of the preceding sheet P2 may overlap the front end of the subsequent sheet P1 according to variation in size of the media sheets P and inclination of the media sheets P at feeding. Conversely, if the predetermined interval t is larger than the minimum interval L, a plurality of suction hole rows may be concurrently located between the preceding sheet P2 and the subsequent sheet P1. This may cause the ink ejected from the print head H (the head units 32) to be sucked into the suction holes 23b by suction through the suction holes 23b, thereby causing a tendency to lower printing quality. Accordingly, it is preferable to set the predetermined interval t to be in the above range. In general, the minimum interval L is larger than 3 mm. Therefore, the predetermined interval t is preferably equal to or larger than 1 mm and equal to or smaller than 3 mm. In the present example embodiment, it is set at approximately 2 mm.

Thus, follow-up of the subsequent sheet P1 to the preceding sheet P2 with the predetermined interval t kept can minimize influence of suction through the suction holes 23b even though the media sheets P are cut sheets. Accordingly, suction of the ink ejected from the print head H into the suction holes 23b, displacement of the adhesion point of the ink to media sheets P, and smears by the ink adhering to media sheets P can be suppressed effectively. As a consequence, printing quality can be increased. Further, the interval formed between consecutive media sheets P can be stably kept small, thereby increasing printing performance per unit time. This is advantageous in consecutive printing on a mass of media sheets.

As described above, follow-up feed by the upstream side roller pair 24 (media sheet follow-up control by the feeding control section 103) can considerably reduce the feed interval between any two consecutive media sheets P in the printing section 21.

Here, in consecutive processing in which the inkjet printer A performs printing and cutting in series on a plurality of media sheets P, the plurality of media sheets P are consecutively fed in the printing section 21 and the cutting section 39 at an interval in the direction where the plurality of media sheets P are fed. In this consecutive processing, if the feed interval between any two consecutive media sheets P in the cutting section 39 remains small as that in the printing section 21, a chip generated by cutting the rear end part of the preceding sheet P2 of the two media sheets P may fall on the subsequent sheet P1 after being blown upward by the movable blade 40b, and a chip generated by cutting the front end part of the subsequent sheet P1 may fall on the preceding sheet P2.

In view of this, in the consecutive processing by the inkjet printer A, the feed interval between any two consecutive media sheets P in the cutting section 39 is set larger than the feed interval (the predetermined interval t) between the two media sheets P in the printing section 21. When the predetermined interval t is approximately 2 mm, the feed interval in the cutting section 39 may be larger than 3 mm and equal to or smaller than 4 mm, for example.

In the present example embodiment, the downstream side roller pair 25 (hereinafter referred to as a pre-cutting roller pair 25) located on the upstream side of the cutter 40, and the upstream side feed roller pair 46 (hereinafter referred to as a post-cutting roller pair 46) of the two feed roller pairs 46 located on the downstream side of the cutter 40 serve as a cutting/feeding section horizontally feeding a printed media sheet P to the side opposite to the printing section 21. Further, the pre-cutting roller pair 25 serves as a pre-cutting feeding section of the cutting/feeding section. The post-cutting roller pair 46 serves as a post-cutting feeding section of the cutting/feeding section. Although the pre-cutting roller pair 25 also serves as the post-printing feeding section of the feeding section 22, another pre-cutting roller pair may be provided in addition to the post-printing feeding section (the downstream side roller pair 25) of the feeding section 22.

The pre-cutting roller pair 25 and the post-cutting roller pair 46 are driven independently of each other for feeding the media sheets P. The feed rate of the preceding sheet P2 is set higher than that of the subsequent sheet P1 when the post-cutting roller pair 46 feeds the preceding sheet P2 of the two media sheet P while the pre-cutting roller pair 25 feeds the subsequent sheet P1 of the two media sheet P. Specifically, when the pre-cutting roller pair 25 and the post-cutting roller pair 46 feed the preceding sheet P2, the drive roller 46a of the post-cutting roller pair 46 is driven at the same rotational speed as that of the drive roller 25a of the pre-cutting roller pair 25. By contrast, when the rear end of the preceding sheet P2 is separated from the pre-cutting roller pair 25, the rotational speed of the drive roller 46a is increased to increase the feed rate of the preceding sheet P2 by the post-cutting roller pair 46. Then, the front end of the subsequent sheet P2 reaches the pre-cutting roller pair 25 and is fed by the pre-cutting roller pair 25. The feed rate of the subsequent sheet P2 fed by the pre-cutting roller pair 25 is the same as that in the printing section 21 and does not vary (and is intermittent). Accordingly, the feed rate of the preceding sheet P2 is higher than that of the subsequent sheet P1 in the cutting section 39. Thus, the feed interval in the cutting section 39 is larger than that in the printing section 21.

In the present example embodiment, the pre-cutting roller pair 25 serves as both the post-printing feeding section of the feeding section 22 and the pre-cutting feeding section of the cutting/feeding section, and feeds the subsequent sheet P1 intermittently. Therefore, it cannot change the feed rate of the subsequent sheet P1. However, only an increase in feed rate of the preceding sheet P2 can provide a sufficient feed interval by the time when the rear end part of the preceding sheet P2 is cut.

By contrast, in the case where the additional pre-cutting roller pair is provided considerably distant from the printing section 21 besides the post-printing feeding section (the downstream side roller pair 25) of the feeding section 22, the rotational speed of the drive roller of the additional pre-cutting roller pair feeding the subsequent sheet P1 is reduced in place of or in addition to an increase in rotational speed of the drive roller 46a of the post-cutting roller pair 46 feeding the preceding sheet P2. This can set the feed rate of the preceding sheet P2 higher than that of the subsequent sheet P1.

Thus, in the present example embodiment, the feed interval of any two consecutive media sheets P in the cutting section 39 is larger than that in the printing section 21. Accordingly, a chip generated by cutting the rear end part of the preceding sheet P2 by the cutter 40 can be prevented from falling on the subsequent sheet P1 after being thrust and blown upward, and a chip generated by cutting the front end of the subsequent sheet P1 is prevented from falling on the preceding sheet P2. The chips fall between the preceding sheet P2 and the subsequent sheet P1, and then is housed in the chip box 41. Thus, paper jam and displacement in the width direction of the media sheets P, which may be caused due to the presence of the chips can be prevented. Further, the feed interval can be minimized in the printing section, thereby improving printing quality.

The present example embodiment describes, but is not limited to, an inkjet printer capable of duplex printing on a media sheet P, and may be applied to inkjet printers capable of only simplex printing.

What is claimed is:

1. An inkjet printer, comprising:
a printing section which prints on media sheets by ejecting ink from a print head;
a media sheet supply section which supplies media sheets to the printing section;
a feeding section which is provided at the printing section, and which feeds the media sheets supplied from the media sheet supply section to a side opposite to a side of the media sheet supply section when the media sheets is being printed; and
a cutting section which sequentially cuts a front end part and a rear end part of the media sheets fed from the feeding section and printed by the printing section,
wherein the cutting section includes
a cutting/feeding section which horizontally feeds the printed media sheets to a side opposite to a side of the printing section, and
a cutter including an upper blade and a lower blade arranged above and below a media sheet feed path of the cutting/feeding section,
the cutting section cuts media sheets in a manner that, when a to-be-cut part of the media sheets is positioned between the upper blade and the lower blade of the cutting/feeding section, the lower blade is moved upward with the upper blade fixed,
in a consecutive processing in which the inkjet printer consecutively prints and cuts a plurality of media sheets, the feeding section and the cutting/feeding section consecutively feed the plurality of media sheets with a feed interval left therebetween in a direction where the media sheets are fed, and
in the consecutive processing by the inkjet printer, the feed interval between any two consecutive media sheets in the cutting section is larger than that in the printing section.

2. The inkjet printer of claim 1, wherein
the cutting/feeding section includes a pre-cutting feeding section and a post-cutting feeding section respectively arranged on an upstream side and a downstream side of the cutter, and driven independently of each other for feeding media sheets, and
in the consecutive processing by the inkjet printer, when the post-cutting feeding section feeds a preceding sheet of the two media sheets while the pre-cutting feeding section feeds a subsequent sheet of the two media sheets, a feed rate of the preceding sheet is higher than that of the subsequent sheet.

3. The inkjet printer of claim 1, further comprising, in the printing section:
a platen opposed to the print head and having a support surface in which a plurality of suction holes are formed; and
a suction device which sucks through the suction holes and hold the media sheets on the support surface of the platen,
wherein the feeding section includes a pre-printing feeding section and a post-printing section respectively arranged on an upstream side and a downstream side of the platen, and driven independently of each other for feeding the media sheets, and
when a rear end of a preceding sheet and a front end of a subsequent sheet of the two media sheets are located between the pre-printing feeding section and the post-printing feeding section in the consecutive processing by the inkjet printer, the pre-printing feeding section performs follow-up feed in which the subsequent sheet follows the preceding sheet at a predetermined interval.

4. The inkjet printer of claim 3, wherein
the pre-printing feeding section includes a press fit type pre-printing feed roller pair which feeds media sheets by being driven by a first motor,
the post-printing feeding section includes a press fit type post-printing feed roller pair which feeds media sheets by being driven by a second motor,
the first motor includes a first rotary encoder which detects a rotation angle of the first motor,
the second motor includes a second rotary encoder which detects a rotation angle of the second motor, and
the follow-up feed by the pre-printing feeding section is performed by driving the first motor on the basis of values detected by the first and second rotary encoders.

5. The inkjet printer of claim 3, wherein
on the support surface of the platen, the plurality of suction holes are arranged such that a plurality of rows of the suction holes, extending along a row direction orthogonal to a feeding direction in which media sheets is fed, are arranged at intervals along the feeding direction, and
the predetermined interval is smaller than a minimum of the intervals at which adjoining ones of the plurality of the rows are arranged.
